(19) United States
(12) Patent Application Publication
(10) Pub. No.: US 2008/0103064 A1
(43) Pub. Date: May 1, 2008

(54) Microscale fluidic devices for electrochemical detection of biological molecules

(75) Inventor: Marc R. Labgold, Reston, VA (US)

Correspondence Address: PATTON BOGGS LLP, 8484 WESTPARK DRIVE, SUITE 900, MCLEAN, VA, 22102, US

(73) Assignee: Antara BioSciences Inc., Mountain View, CA (US)

(21) Appl. No.: 11/808,785

(22) Filed: Jun. 13, 2007

Related U.S. Application Data
(60) Provisional application No. 60/813,027, filed on Jun. 13, 2006.

(51) Int. Cl. C40B 60/10

(52) U.S. Cl. 506/38

(57) ABSTRACT

The present invention provides microdevices for electrochemical detection of target agents in a fluid sample. The microdevices each comprise an elongated microstructure having an inlet for introduction of a fluid sample potentially containing a target agent, and an outlet to allow the sample to flow through the region of the microdevice that allows detection of the target agent. This detection is mediated through hybridization of nucleic acids corresponding to a target agent with device-associated nucleic acids and subsequent binding of an electrochemical detection agent to allow the transfer of an electron to or from the electrode. In specific embodiment, the device comprises: a hollow elongated microstructure with a conductive surface on the internal surface; b) insulating polymer that is uniformly distributed on the conductive surface; c) adapter molecule associated with the insulating polymer, and d) a plurality of associated nucleic acids conjugated to the polymer surface in a specific orientation.

### FIELD OF THE INVENTION

This invention relates to small-scale devices for rapid detection of biological target agents in a sample, methods of using such devices, and incorporation of these devices into detection systems.

### BACKGROUND OF THE INVENTION

In the following discussion certain articles and methods will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

A variety of assays for detecting a target agent in a sample have been developed, and these technologies are widely used in numerous fields, including the medical field for diagnosis of disease, the food industry for detection of contaminants, and in law enforcement for the detection of drugs or drug metabolites.

A biosensor is defined as being a unique combination of a moiety for molecular recognition, for example a selective layer with immobilized nucleic acids, and a transducer for transmitting the interaction information to processable signals. There is increasing interest in developing electrochemical biosensors capable of detecting and quantifying target agents in a sample. The interest in biosensors is spurred by a number of potential advantages over strictly biochemical assay formats. First, electrochemical biosensors may be produced, using conventional microchip technology, in highly reproducible and miniaturized form, with the capability of placing a large number of biosensor elements on a single substrate (e.g., see U.S. Pat. Nos. 5,200,051 and 5,212,050). Secondly, because small electrochemical signals can be readily amplified (and subjected to various types of signal processing if desired), electrochemical biosensors have the potential for measuring minute quantities of a target agent, and proportionately small changes in target agent levels. Importantly, biosensors may offer this exquisitely sensitive detection at a lower cost than currently available assay methods.

One general type of biosensor employs an electrode surface in combination with current or impedance measuring elements for detecting a change in current or impedance in response to the presence of a ligand-receptor binding event. This type of biosensor is disclosed, for example, in U.S. Pat. No. 5,567,301. Biosensors based on surface plasmon resonance (SPR) effects have also been proposed, for example, in U.S. Pat. No. 5,485,277. These devices exploit the shift in SPR surface reflection angle that occurs with perturbations, e.g., binding events, at the SPR interface. Yet other biosensors that utilize changes in optical properties at a biosensor surface are known, e.g., U.S. Pat. No. 5,268,305.

Gravimetric biosensors employ a piezoelectric crystal to generate a surface acoustic wave whose frequency, wavelength and/or resonance state are sensitive to surface mass on the crystal surface. The shift in acoustic wave properties is therefore indicative of a change in surface mass, e.g., due to a ligand-receptor binding event. U.S. Pat. Nos. 5,478,756 and 4,789,804 describe gravimetric biosensors of this type.

Heretofore, electrochemical biosensors have been more successfully applied to detecting analytes that are themselves electrochemical species, or can participate in catalytic reactions that generate electrochemical species, than to detecting passive target agents in a sample. This is not surprising, given the more difficult challenge of converting a biochemical binding event to an electrochemical signal. Biosensors that attempt to couple electrochemical activity directly to an analyte-receptor binding event, by means of gated membrane electrodes, have been proposed. For example, U.S. Pat. Nos. 5,204,239 and 5,368,712 disclose gated membrane electrodes formed of a lipid bilayer membrane containing an ion-channel receptor that is either opened or closed by analyte binding to the receptor. Electrodes of this type are difficult to make and store, and are limited at present to a rather small group of receptor proteins.

Previous approaches have used receptors embedded in a thin polymer film to directly measure electrochemical changes due to analyte-receptor binding. The binding has been measured through changes in the film's electrical properties, e.g., impedance, due to analyte binding to the receptors. See U.S. Pat. No. 5,192,507. Since analyte binding to the receptor will have a rather small direct effect on film properties due to impedence, and since no amplification effect is achieved using this method, the approach is expected to have limited sensitivity.

There is thus a need in the field for improved biosensors with the ability to measure target agents in a biological sample. The present invention addresses this need.

### SUMMARY OF THE INVENTION

The present invention provides microdevices for electrochemical detection of target agents in a fluid sample. The microdevices of the invention each comprise an elongated microstructure having an inlet for introduction of a fluid sample potentially containing a target agent, and an outlet to allow the sample to flow through the region of the microdevice that allows detection of the target agent. This detection is mediated through hybridization of nucleic acids corresponding to a target agent with device-associated nucleic acids and subsequent binding of an electrochemical detection agent to allow the transfer of an electron to or from the electrode. The use of hollow detection microdevices of the invention provide an increased surface area available for hybridization and electrochemical detection of any biological target agent in a sample in comparison to a planar surface hybridization devices; e.g., a conventional microarray chip.

The microdevices provide a flow channel created by the structure of the microdevice, with the sample introduced into the flow channel via the inlet. The hollow structure of the microdevice creates an improved flow channel for the movement of a sample through the device for detection of target agents. The creation of such a flow channel facilitates integration of the device into diagnostic systems for automation of the diagnostic procedures.

In one embodiment, the device comprises: a) a hollow elongated microstructure comprising a conductive surface, e.g., gold, platinum, or carbon, on the internal surface of the device; b) a polymer that is uniformly distributed on the conductive surface of the hollow microstructure; c) an adapter molecule associated with the electroactive polymer, e.g., a coupling agent such as avidin or strepavidin and d) a plurality of associated nucleic acids conjugated to the polymer surface in a specific orientation.

In specific embodiment, the device comprises: a) a hollow elongated microstructure comprising a conductive surface, e.g., gold, platinum, or carbon, on the internal surface of the device; b) an insulating polymer that is uniformly distributed on the conductive surface of the hollow microstructure; c) an adapter molecule associated with the insulating polymer, e.g., a coupling agent such as avidin or strepavidin and d) a plurality of associated nucleic acids conjugated to the polymer surface in a specific orientation.

The insulating polymers facilitate the conjugation of nucleic acids for detection of the target agent in a sample by specific distribution of polymers conjugated to a binding molecule, e.g., avidin or strepavidin.

In a specific embodiment, the polymer used is an electroconductive polymer. The electroconductive polymer coating on the inner surface of the device performs a dual function, serving both to bind the nucleic acid to the internal surface of the electrode device, and to render the electrode sensitive to variations in the composition of the buffer solution. In particular, changes in the composition of the buffer solution which affect the redox composition of the electroconductive polymer result in a corresponding change in the steady state potential of the detection electrode. The polymers facilitate the conjugation of nucleic acids for detection of the target agent in a sample by specific distribution of polymers conjugated to a binding molecule, e.g., avidin or strepavidin. The avidin or strepavidin in return provides a blocking agent to prevent reducing non-specific interactions of the sample with the conductive surface due to the blocking of the free surfaces of the electroconductive polymer by the avidin or strepavidin.

In a specific embodiment, the electroconductive polymer used in the device is an ionically conductive biocompatible polymer, which is capable of reversible reduction-oxidation. Such biocompatible polymers can be insulating materials that become electrically conductive in the presence of fluids with specific ions present. Examples of such polymers include, but are not limited to, polytetrafluoroethylene (PTFE). The conditions under which such polymers are used will be determinative of their insulating or conductive behavior.

In a specific aspect of this embodiment, the electroconductive polymer has been doped with dopant anions, e.g., dodecyl sulphate or dextran sulphate.

In one embodiment, the device-associated nucleic acids are of the same sequence, which is useful when attempting to detect and quantify very low levels of a target agent in a sample. Identification and quantification of the target agent is provided by detection of electron transfer to or from the conductive surface of the device.

In another embodiment, the present invention utilizes surface chemistries adapted for multiparameter analysis of a sample, e.g. conjugation of multiple different nucleic acids to the internal surface of the device to allow simultaneous detection of multiple target agents in a sample. Identification and quantification is effected by electron transfer to or from the conductive surface of the device at specific locations corresponding to know nucleic acid sequences.

In yet another embodiment, the devices and methods of the invention comprise integrated diagnostic systems incorporating the nucleic acid detection device of the invention. The biological detection devices of the invention provide electrochemical detection integrated into a diagnostic system to perform high-sensitivity identification and quantification of a biological target agent in a sample.

These and other objects, advantages, and features of the invention will become apparent to those persons skilled in the art upon reading the details of the methods and formulations as more fully described below.

### BRIEF DESCRIPTION OF THE DRAWINGS

FIG. 1 is a schematic diagram illustrating the side view of a first embodiment of the microdevice of the present invention.

FIG. 2 is a schematic diagram illustrating the cross-sectional view of a first embodiment of the microdevice of the present invention.

FIG. 3 is a schematic diagram illustrating the side view of a second embodiment of the microdevice of the present invention.

FIG. 4 is a schematic diagram illustrating the cross-sectional view of a first embodiment of the microdevice of the present invention.

FIG. 5 is a first schematic diagram illustrating the use of a microdevice of the invention in an integrated diagnostic system.

FIG. 6 is a second schematic diagram illustrating the use of a microdevice of the invention in an integrated diagnostic system.

### DETAILED DESCRIPTION OF THE INVENTION

Before the present devices, systems and methods are described, it is to be understood that this invention is not limited to the particular systems, device structure, or methods described, as such may, of course, vary. It is also to be understood that the terminology used herein is for the purpose of describing particular embodiments only, and is not intended to limit the scope of the present invention which will be limited only by appended claims.

It must be noted that as used herein and in the appended claims, the singular forms “a,” “and,” and “the” include plural referents unless the context clearly dictates otherwise. Thus, for example, reference to “a sample” refers to one or mixtures of samples, and reference to “an assay” includes reference to equivalent steps and methods known to those skilled in the art, and so forth.

Unless defined otherwise, all technical and scientific terms used herein have the same meaning as commonly understood by one of ordinary skill in the art to which this invention belongs. All publications mentioned herein are incorporated herein by reference for the purpose of describing and disclosing devices, formulations and methodologies which are described in the publication and which might be used in connection with the presently described invention.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

In the following description, numerous specific details are set forth to provide a more thorough understanding of the present invention. However, it will be apparent to one of skill in the art that the present invention may be practiced without one or more of these specific details. In other instances, well-known features and procedures well known to those skilled in the art have not been described in order to avoid obscuring the invention.

Generally, conventional techniques within the skill of the art are employed in the present invention. Such techniques are explained fully in the literature, see, e.g., Maniatis, Fritsch & Sambrook, Molecular Cloning: A Laboratory Manual (1982); Sambrook, Russell and Sambrook, Molecular Cloning: A Laboratory Manual (2001); Harlow, Lane and Harlow, Using Antibodies: A Laboratory Manual: Portable Protocol NO. 1, Cold Spring Harbor Laboratory (1998); and Harlow and Lane, Antibodies: A Laboratory Manual, Cold Spring Harbor Laboratory; (1988).

### DEFINITIONS

The terms “nucleic acid” and “nucleic acid molecules” as used interchangeably herein refer to linear oligomers of natural or modified nucleic acid monomers or linkages, including deoxyribonucleotides, ribonucleotides, anomeric forms thereof, peptide nucleic acid monomers (PNAs), locked nucleotide acid monomers (LNA), and the like, capable of specifically binding to a single stranded polynucleotide by way of a regular pattern of monomer-to-monomer interactions, such as Watson-Crick type of base pairing, base stacking, Hoogsteen or reverse Hoogsteen types of base pairing, or the like. Usually monomers are linked by phosphodiester bonds or analogs thereof to form oligonucleotides ranging in size from a few monomeric units, e.g., 8-12, to several tens of monomeric units, e.g., 100-200. Usually nucleic acid molecules of the invention comprise the five natural nucleotides; however, they may also comprise methylated or non-natural nucleotide analogs. Suitable nucleic acid molecules may be prepared by the phosphoramidite method described by Beaucage and Carruthers (Tetrahedron Lett., 22, 1859-1862, 1981), or by the triester method according to Matteucci, et al. (J. Am. Chem. Soc., 103, 3185, 1981), both incorporated herein by reference, or by other chemical methods such as using a commercial automated oligonucleotide synthesizer.

The phrase “nucleic acid corresponding to a target agent” refers to a nucleic acid with a specific sequence complementary to a device-associated nucleic acid, where presence and hybridization of the nucleic acid to the device-associated nucleic acid is indicative of the presence of the target agent in the sample tested. In certain embodiments, the nucleic acid itself is the target agent.

“Hybridization” methods typically involve the annealing of complementary nucleic acid sequences. The ability of two polymers of nucleic acid containing complementary sequences to find each other and anneal through base pairing interaction is a well-recognized phenomenon.

The term “sample” in the present specification and claims is used in its broadest sense and can be, by non-limiting example, any fluid sample that is suspected of containing the agents to be detected. It is meant to include a specimen or culture (e.g., microbiological cultures), biological and environmental samples. Biological samples may comprise animal derived materials, including derivations from solids (e.g., tissues or organs), as well as liquid food and fluids derived from or containing feed products and ingredients such as dairy items, vegetables, meat and meat by-products, and waste. Biological samples may be obtained from any domestic or wild animals. Environmental samples can include environmental material such as surface matter, soil, water, air and industrial samples, as well as samples obtained from food and dairy processing instruments, apparatus, equipment, utensils, disposable and non-disposable items. These examples are not to be construed as limiting the sample types applicable to the present invention. Those of skill in the art would appreciate and understand the particular type of sample required for the detection of particular agents.

By “electrode” herein is meant a composition, which, when connected to an electronic device, is able to conduct, transmit, receive or otherwise sense a current or charge. This current or charge is subsequently converted into a detectable signal. Alternatively an electrode can be defined as a composition, which can apply a potential to and/or pass electrons to or from a chemical moiety.

The phrase “nucleic acid corresponding to a target agent” refers to a nucleic acid with a specific sequence complementary to a device-associated nucleic acid, where presence and hybridization of the nucleic acid to the device-associated nucleic acid is indicative of the presence of the target agent in the sample tested.

### Exemplary Devices of the Invention

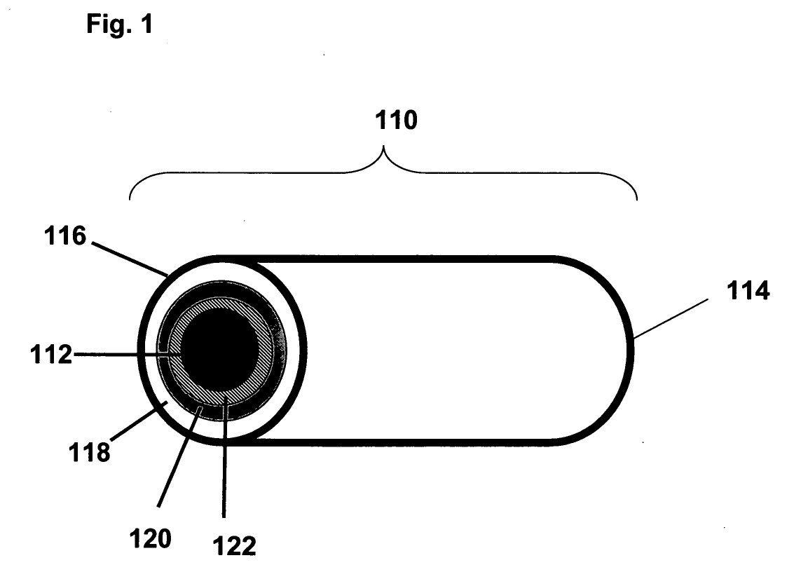

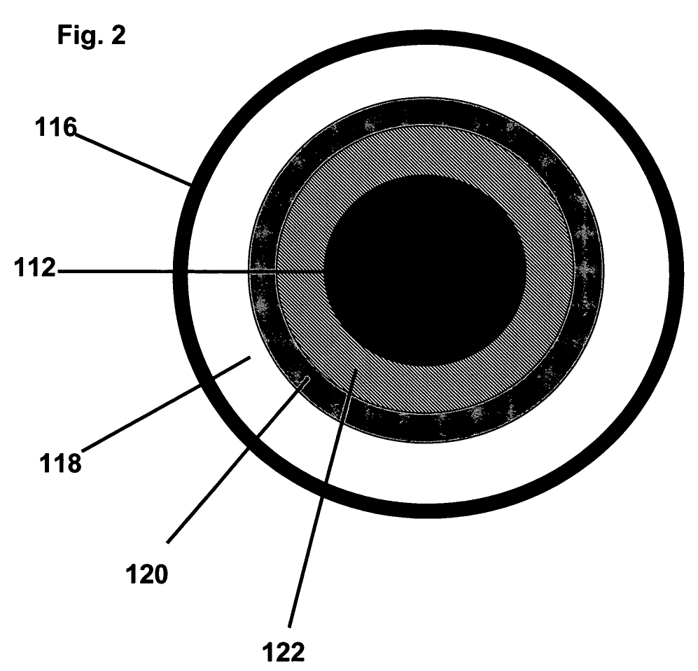

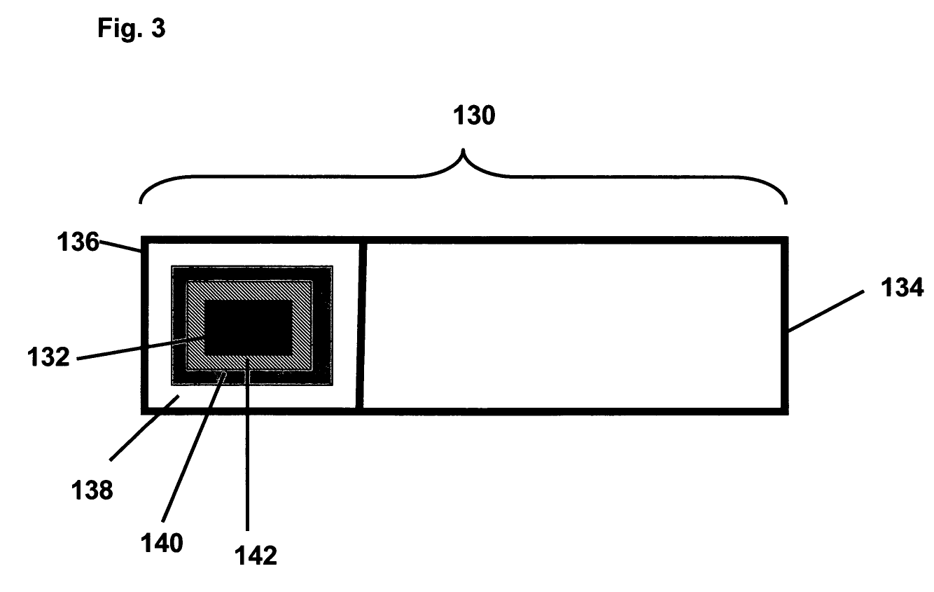

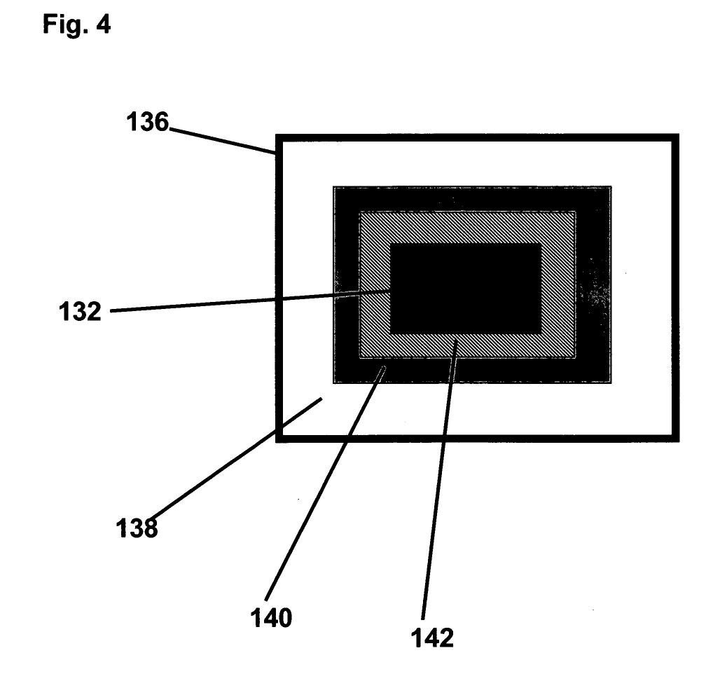

Exemplary detection microdevices of the invention are illustrated in FIGS. 1-4. FIGS. 1 and 2 are schematic diagrams illustrating an embodiment comprising a device that has a hollow, elongated tube conformation, and FIGS. 3 and 4 are schematic diagrams illustrating an embodiment comprising a device that has a hollow, elongated rectangular conformation.

FIG. 1 provides a side view and FIG. 2 provides a cross-sectional view of the first exemplary embodiment of a microdevice of the invention. The microdevice (10) comprises an elongated tube with an inlet (112) and an outlet (114) providing flow-through access of a sample to the detection device. The device itself provides an outside surface (116) onto which a conductive material is deposited to form an electrode (118). A thin, uniform layer of a polymer (120) is bound to the internal surface of the conductive material. Nucleic acids for detection of the target agent (122) are bound to the polymer using an adaptor molecule and its binding partner.

FIG. 3 provides a side view and FIG. 4 provides a cross-sectional view of a second exemplary embodiment of a microdevice of the invention. In a second exemplary embodiment, the microdevice (130) comprises an elongated tube with an inlet (132) and an outlet (134) providing flow-through access of a sample to the detection device. The device itself provides an outside surface (136) onto which a conductive material is deposited to form an electrode (138). A thin, uniform layer of a polymer (140) is bound to the internal surface of the conductive material. Nucleic acids for detection of the target agent (142) are bound to the polymer using an adaptor molecule and its binding partner.

### Manufacture of the Microscale Electrochemical Detection Devices

The hollow electrode structure of the invention can be created using any conductive material that will allow the detection of electron flow to or from the surface. http://patft.uspto.gov/netacgi/nph-Parser?Sect1=PTO1&Sect2=HITOFF&d=PALL&p=1&u=%2Fnetahtml%2FPTO%2Fsrchnum.htm&r=1&f=G&1=50&s1=5147590.PN.&OS=PN/5147590&RS=PN/5147590-h0#h0http://patft.uspto.gov/netacgi/nph-Parser?Sect1=PTO1&Sect2=HITOFF&d=PALL&p=1&u=%2Fnetahtml%2FPTO%2Fsrchnum.htm&r=1&f=G&1=50&s1=5147590.PN.&OS=PN/5147590&RS=PN/5147590-h2#h2 Preferred electrodes are known in the art and include, but are not limited to, certain metals and their oxides, including gold; platinum; palladium; silicon; aluminum; titanium, metal oxide electrodes including platinum oxide, titanium oxide, tin oxide, indium tin oxide, palladium oxide, silicon oxide, aluminum oxide, molybdenum oxide (Mo₂, O₆), tungsten oxide (WO₃) and ruthenium oxides; carbon (including glassy carbon electrodes, graphite, pyrolytic graphite, carbon fiber, and carbon paste); and semiconductor electrodes, such as Si, Ge, ZnO, CdS, TiO₂ and GaAs. Preferred electrodes include gold, silicon, platinum, carbon and metal oxide electrodes, with gold and glassy carbon being particularly preferred.

The electrodes can be formed on any inert, hollow solid surface, including glass or polymer substrates. Thus, in general, the suitable substrates for creation of the hollow microstructure include, but are not limited to, fiberglass, Teflon, ceramics, glass, silicon, mica, plastic (including acrylics, polystyrene and copolymers of styrene and other materials, polypropylene, polyethylene, polybutylene, polycarbonate, polyurethanes, Teflon™, and derivatives thereof, etc.), GETEK (a blend of polypropylene oxide and fiberglass), and other materials typically employed and readily known to those of ordinary skill in the art.

Exemplary methods for producing such hollow structures are described in U.S. Pat. No. 5,147,590 to Preidel, et al., U.S. Pat. No. 5,614,246 to Mund, et al. and U.S. Pat. No. 6,143,412, each of which describe methods of creating hollow electrodes from conductive materials such as glassy carbon and are incorporated by reference to teach creation of the hollow electrode structures.

In one embodiment of the invention, a film of electroconductive polymer is deposited onto the internal surface of an electrically conductive hollow electrode by electrochemical synthesis from a monomer solution introduced into the hollow structure.

Electrodeposition of the electroconductive polymer film can be carried out, e.g., according to the methods disclosed in U.S. Pat. No. 6,770,190 to Milanovski, et al. In such an exemplary method, a solution containing monomers, a polar solvent and a background electrolyte are used for deposition of the polymer.

Electroconductive polymers can be doped at the electrochemical synthesis stage to modify the structure and/or conduction properties of the polymer. A typical dopant anion is sulphate (SO₄²⁻), which is incorporated during the polymerisation process to neutralize any positive charge on the polymer backbone. Sulphate is not readily released by ion exchange and thus helps to maintain the structure of the polymer. Dopant anions having maximum capability for ion exchange with the solution surrounding the polymer can be used to increase the sensitivity of the electrodes. This is accomplished by using a salt with anions having a large ionic radius as the background electrolyte when preparing the electrochemical polymerisation solution, e.g., sodium dodecyl sulphate and dextran sulphate. The concentration of these salts in the electrochemical polymerisation solution is varied according to the type of test within the range 0.005-0.05 M.

In another embodiment, the electroactive polymer is introduced to the surface of the electrode via an introduced functional group, e.g., a sulfide, disulfide, amino, amide, amido, a carboxyl, a hydroxyl, carbonyl, oxide, phosphate, sulfate, aldehyde, keto, thiol, ester or mercapto groups. Other highly reactive functional groups may also be employed using methods readily known to those of ordinary skill in the art. For example, polymers with an associated thiol group can be bound directly to a gold or platinum surface. This embodiment may be preferable for the use of more complex polymers that are difficult to synthesize using monomer deposition.

Adaptor molecules may either be immobilized in the electroconductive polymer film at the electrochemical synthesis stage by adding adaptor molecules to the electrochemical polymerisation solution or may be adsorbed onto the surface of the electroconductive polymer film after electrochemical polymerisation. In the former case, a solution of adaptor molecules may be added to the electrodeposition solution immediately before the deposition process. The deposition process works optimally if the storage time of the finished solution does not exceed 30 minutes. Depending on the particular type of test, the concentration of adaptor molecules in the solution may be varied in the range 5.00-100.00μ/ml. Procedures for electrodeposition of the electroconductive polymer from the solution containing adaptor molecules are described in the examples included herein. On completion of electrodeposition process, the detection electrode obtained may be rinsed successively with deionised water and 0.01 M phosphate-saline buffer solution and, depending on the type of test, may then be placed in a special storage buffer solution containing microbial growth inhibitors or bactericidal agents (e.g., gentamicin), or dried in dust-free air at room temperature.

Where the adaptor molecules are to be adsorbed after completion of the electrodeposition process the following protocol may be used (although it is hereby stated that the invention is in no way limited to the use of this particular method), the detection electrode is first rinsed with deionised water and placed in freshly prepared 0.02M carbonate buffer solution, where it is held for 15-60 minutes. The detection electrode is then placed in contact with freshly-prepared 0.02M carbonate buffer solution containing adaptor molecules at a concentration of 1.00-50.00 μg/ml, by immersing the detection electrode in a vessel filled with solution, or by placing a drop of the solution onto the surface of the detection electrode. The detection electrode is incubated with the solution of adaptor molecules, typically for 1-24 hours at +4° C. After incubation, the detection electrode is rinsed with deionised water and placed for 1-4 hours in a 0.1 M phosphate-saline buffer solution. Depending on the type of test, the detection electrode may then be placed either in a special storage buffer solution containing microbial growth inhibitors or bactericidal agents, or dried in dust-free air at room temperature.

When the adaptor molecules are avidin or streptavidin, the above-described methods of the invention for comprise a further step of contacting the coated electrode with a solution comprising specific nucleic acids conjugated with biotin such that said biotinylated nucleic acids bind to molecules of avidin or streptavidin immobilised in or adsorbed to the electroconductive polymer coating of the electrode via a biotin/avidin or biotin/streptavidin binding interaction. Conjugation of biotin with the corresponding nucleic acid, a process known to those skilled in the art as biotinylation, can be carried out using procedures well known in the art.

Biotinylated peptidic spacers, generally from between 0.4 and 2 nm in length, can also be used to couple the adaptor molecule to the nucleic acid. The resulting conjugates can be immobilized on the microdevice electrode surface through specific binding to the adaptor molecule. The electron transfer through multilayers of the conjugates is strongly dependent on the length of the spacer between the nucleic acid (and thus any bound electrochemical detection agent) and the electrode surface. The redox current through the layer is dependent on external parameters such as the applied voltage difference between the two electrode arrays or the temperature.

### Use of Adaptor Molecules in the Microdevices

The proteins avidin and streptavidin are preferred for use as adaptor molecules. Avidin consists of four identical peptide sub-units, each of which has one site capable of bonding with a molecule of the co-factor biotin. Biotin (vitamin H) is an enzyme co-factor present in very minute amounts in every living cell and is found mainly bound to proteins or polypeptides. The ability of biotin molecules to enter into a binding reaction with molecules of avidin or streptavidin (a form of avidin isolated from certain bacterial cultures, for example Streptomyces aviation) and to form virtually non-dissociating “biotin-avidin” complexes during this reaction (with a dissociation constant of about 10⁻¹⁵ Mol/l).

The electrodes of the invention can be produced in a disposable format, intended to be used for a single electrochemical detection experiment or a series of detection experiments and then thrown away. The invention further provides an electrode assembly including both a detection electrode and a reference electrode required for electrochemical detection. Conveniently, the electrode assembly could be provided as a disposable unit comprising a housing or holder manufactured from an inexpensive material equipped with electrical contacts for connection of the detection electrode and reference electrode.

The electroconductive polymer layer performs a dual function, serving both to bind the nucleic acid to the surface of the detection electrode, and to render it sensitive to variations in the composition of the buffer solution. In particular, changes in the composition of the buffer solution which affect the redox composition of the electroconductive polymer result in a corresponding change in the steady state potential of the detection electrode.

Where the adaptor molecules are to be adsorbed after completion of the electrodeposition process the following protocol may be used (although it is hereby stated that the invention is in no way limited to the use of this particular method), the detection electrode is first rinsed with deionised water and placed in freshly prepared 0.02M carbonate buffer solution, where it is held for 15-60 minutes. The detection electrode is then placed in contact with freshly-prepared 0.02M carbonate buffer solution containing adaptor molecules at a concentration of 1.00-50.00 μg/ml, by immersing the detection electrode in a vessel filled with solution, or by placing a drop of the solution onto the surface of the detection electrode. The detection electrode is incubated with the solution of adaptor molecules, typically for 1-24 hours at +4° C. After incubation, the detection electrode is rinsed with deionised water and placed for 1-4 hours in a 0.1M phosphate-saline buffer solution. Depending on the type of test, the detection electrode may then be placed either in a special storage buffer solution containing microbial growth inhibitors or bactericidal agents, or dried in dust-free air at room temperature.

When the adaptor molecules are avidin or streptavidin, the above-described methods of the invention for producing a detection electrode comprises a further step of contacting the coated electrode with a solution comprising specific nucleic acids conjugated with biotin such that said biotinylated receptors bind to molecules of avidin or streptavidin immobilised in or adsorbed to the electroconductive polymer coating of the electrode via a biotin/avidin or biotin/streptavidin binding interaction.

Techniques which allow the conjugation of biotin to a wide range of different molecules are well known in the art. Thus detection electrodes with immobilised avidin or streptavidin can easily made specific for a given target merely by binding of the appropriate biotinylated receptors. Other similar members of binding pair are intended to be within the scope of the present invention, and use of such will be known to one skilled in the art upon reading the present disclosure.

The use of adaptor molecules on the polymer layer considerably improves the reliability of the results obtained during electrochemical analysis by reducing non-specific interactions of the components of the sample during contact with the detection electrode, due to the blocking of the free surface of an electroconductive polymer by adaptor molecules. The use of adaptor molecules also increases the technical efficiency of the detection electrode manufacturing process, for example by eliminating the need for an additional surface blocking procedure.

### Polymers for Use in the Present Invention

The polymer for use in the present invention must be capable of binding to the adaptor molecule, directly or indirectly (e.g., through the use of a linker or peptidic spacer molecule). The thickness of the polymer is selected to provide the appropriate distance between the surface and the nucleic acid detection groups used to identify and quantify a target agent in a sample. In this manner, the nucleic acids can be bound to the internal surface of the device surface in a configuration that provides the nucleic acids with a spatial distribution to optimize hybridization to any target agent. The polymers used are preferably hydrophilic, e.g., polyacrylamide and polyvinylpyrrolidone being examples of such polymers.

This polymeric material is non-biodegradable and preferably biocompatible, and serves as the substrate for providing an electrically conductive path by way of either any suitable electrically conductive coatings deposited on the polymer surface, or any suitable electrically conductive particles blended with the polymer. It is critical that in all these variants, the electrical conductivity is a fundamental material characteristic and not based on porosity.

Polymers for use in the present invention include acrylics, vinyls, nylons, polyurethanes, polycarbonates, polyamides, polysulfones, poly(ethylene terephthalate), polylactic acid, polyglycolic acid, polydimethylsiloxanes, polyetheretherketone and polytetrafluoroethylene. In one embodiment, the device comprises a polymer substrate of polyester, polyolefin or polyurethane. In a further embodiment the device comprises a polymer substrate selected from the group consisting of polyethylene terephthalate, polyethylene, polyether urethane and polysiloxane urethane.

In a specific embodiment, the polymer is a biocompatible material such as are polylactic acid polyglycolic acid, polyvinyl alcohol, or similar materials.

In another specific embodiment, the device comprises an acrylic such as those polymerized from hydroxyethyl acrylate, hydroxyethyl methacrylate, glyceryl acrylate, glyceryl methacrylate, acrylic acid, methacrylic acid, acrylamide and methacrylamide; vinyls such as polyvinyl pyrrolidone and polyvinyl alcohol; nylons such as polycaprolactam; derivatives of polylauryl lactam, polyhexamethylene adipamide and polyhexamethylene dodecanediamide, and polyurethanes; polyethers such as polyethylene oxide, polypropylene oxide, and polybutylene oxide; and biodegradable polymers such as polylactic acid, polyglycolic acid, polydioxanone, polyanhydrides, and polyorthoesters.

The polymers can be deposited on the conductive surface of the device in any thickness that will allow efficient and accurate detection of an electrochemical signal effected by hybridization of the nucleic acid corresponding to a target agent to the device-associated nucleic acid. The length of the polymer will impact on the efficiency of the electrochemical detection, so it is preferable to have a thin, uniform film of the polymer that will not impede transfer of the electron to or from the electrode. In a preferred embodiment, the polymer is a uniform layer of not more that 20 Å in thickness.

In a particular embodiment, the polymer used is Parylene™ (Comelec S A, Switzerland), which has the ability to solidify directly from the gaseous phase at ambient temperature. The treatment results in a linear, crystalline structure that has superior protection qualities at low application thickness. The ability to solidify at ambient temperatures affords the Parylene coating high conformity and uniformity, as well as ensuring that they free of porosity or defects

### Electrochemical Detection Agents

To facilitate detection of resulting binding of the detector agent to the target agent, an electrochemical detection agent is used to effect an electrochemical reaction on a detection electrode.

The electrochemical hybridization detector can be, for example, a DNA binding agent characterized by a tendency to intercalate specifically to double stranded nucleic acid such as double stranded DNA. These intercalating agents have in their molecules a flat intercalating group such as a phenyl group, which intercalates between the base pairs of the double stranded nucleic acid, therefore binding to the double stranded nucleic acid. Most intercalating agents comprise conjugated electron structures and are therefore optically active; some are commonly used in the quantification or visualization of nucleic acids. Certain intercalating agents exhibit an electrode response, thereby generating or enhancing an electrochemical response. As such, determination of physical change, especially electrochemical change, may serve to detect the intercalating agents bound to a double stranded nucleic acid and so enhance the detection of a hybridization reaction.

Electrochemically active binding agents useful in the present invention are, but are not limited to, ethidium, ethidium bromide, acridine, aminoacridine, acridine orange, proflavin, ellipticine, actinomycin D, daunomycin, mitomycin C, HOECHST 33342, HOECHST 33258, aclarubicin, DAPI, Adriamycin, pirarubicin, actinomycin, tris (phenanthroline) zinc salt, tris (phenanthroline) ruthenium salt, tris (phenantroline) cobalt salt, di (phenanthroline) zinc salt, di (phenanthroline) ruthenium salt, di (phenanthroline) cobalt salt, bipyridine platinum salt, terpyridine platinum salt, phenanthroline platinum salt, tris (bipyridyl) zinc salt, tris (bipyridyl) ruthenium salt, tris (bipyridyl) cobalt salt, di (bipyridyl) zinc salt, di (bipyridyl) ruthenium salt, di (bipyridyl) cobalt salt, and the like. Other intercalating agents, which are useful, are those listed in Published Japanese Patent Application No. 62-282599. Some of these binders contain metal ions and can be considered transition metal complexes. Although the transition metal complexes are not limited to those listed above, complexes which comprise transition metals having oxidation-reduction potentials not lower than or covered by that of nucleic acids are less preferable. The concentration of the binder depends on the type of binder to be used, but it is typically within the range of 1 ng/ml to 1 mg/ml. Some of these binders, specifically Hoechst 33258, has been shown to be a minor-groove binder and specifically binds to double-stranded DNA. The use of such electrochemically active minor groove binders is useful for detection of hybridization in electrochemical detection methods.

In certain embodiments, this electrochemical detection agent will bind directly to any nucleic acid hybrid formed on the biosensor. In this embodiment, the electrochemical signal on the biosensor is created by an electrochemically active compound that specifically binds to double-stranded nucleic acids, e.g., a minor groove binding ligand such as the molecules of the netropsin family. In other embodiments, the electrochemical detection agent will be bound to an RNA:DNA antibody specific to a hybrid nucleic acid associated with a detection electrode. In yet other embodiments, both of these methods of detection are employed.

In one specific embodiment of the invention, the nucleic acid duplex detection is an electrochemical detection binders of the netropsin family, which includes netropsin, distamycin, DAPI, SN 6999, Berenil, and Hoechst 33258. Each of these molecules has a curved, planar aromatic core, and positively charged groups and hydrogen-bond donors on the convex edge. Both the shape and the functional group complementarity with the nucleic acid sequence are critical features for the binding of these ligands to the nucleic acid duplex.

The binding ratio of the minor groove ligands may be either in a 1:1 ratio in the minor groove or in a 2:1 ratio. In the latter case, the ligands will be bound side by side in the minor groove, running antiparallel. The preference for 1:1 versus 2:1 binding will be largely be a function of the groove shape of the nucleic acid duplex, as the 2:1 binding of the ligand results in a minor groove that is widened by approximately 3.5 to 4 Å relative to the 1:1 complexes.

Transition metals are those whose atoms have a partial or completed orbital shell of electrons. Suitable transition metals for use in conjunction with the present invention include, but are not limited to, cadmium (Cd), copper (Cu), cobalt (Co), palladium (Pd), zinc (Zn), iron (Fe), ruthenium (Ru), rhodium (Rh), osmium (Os), rhenium (Re), platinum (Pt), scandium (Sc), titanium (Ti), Vanadium (V), chromium (Cr), manganese (Mn), nickel (Ni), Molybdenum (Mo), technetium (Tc), tungsten (W), and iridium (Ir). That is, the first series of transition metals, the platinum metals (Ru, Rh, Pd, Os, Ir and Pt), along with Fe, Re, W, Mo and Tc, are preferred. Particularly preferred are ruthenium, rhenium, osmium, platinum, cobalt and iron.

The transition metals are commonly complexed with a variety of ligands, to form suitable transition metal complexes. As will be appreciated by those in the art, the number and nature of the co-ligands will depend on the coordination number of the metal ion. Mono-, di- or polydentate co-ligands may be used at any position. Suitable ligands fall into two categories: ligands, which use nitrogen, oxygen, sulfur, carbon or phosphorus atoms (depending on the metal ion) as the coordination atoms (generally referred to in the literature as sigma (Σ) donors) and organometallic ligands such as metallocene ligands (generally referred to in the literature as pi (π) donors). Suitable nitrogen donating ligands are well known in the art and include, but are not limited to, NH₂; NHR; NRR′; pyridine; pyrazine; isonicotinamide; imidazole; bipyridine and substituted derivatives of bipyridine; terpyridine and substituted derivatives; phenanthrolines, particularly 1,10-phenanthroline (abbreviated phen) and substituted derivatives of phenanthrolines such as 4,7-dimethylphenanthroline and dipyridol[3,2-a:2′,3′-c]phenazine (abbreviated dppz); dipyridophenazine; 1,4,5,8,9,12-hexaazatriphenylene (abbreviated hat); 9,10-phenanthrenequinone diimine (abbreviated phi); 1,4,5,8-tetraazaphenanthrene (abbreviated tap); 1,4,8,11-tetra-azacyclotetradecane (abbreviated cyclam), EDTA, EGTA and isocyanide. Substituted derivatives, including fused derivatives, may also be used. In some embodiments, porphyrins and substituted derivatives of the porphyrin family may be used. See for example, Comprehensive Coordination Chemistry, Ed. Wilkinson et al., Pergammon Press, 1987, Chapters 13.2 (pp 73-98), 21.1 (pp. 813-898) and 21.3 (pp 915-957), all of which are hereby expressly incorporated by reference.

Suitable sigma donating ligands using carbon, oxygen, sulfur and phosphorus are known in the art. For example, suitable sigma carbon donors are found in Cotton and Wilkinson, Advanced Organic Chemistry, 5th Edition, John Wiley & Sons (1988), hereby incorporated by reference; see, e.g., page 38. Similarly, suitable oxygen ligands include crown ethers, water and others known in the art. Phosphines and substituted phosphines are also suitable; see, e.g., page 38 of Cotton and Wilkinson. The oxygen, sulfur, phosphorus and nitrogen-donating ligands are attached in such a manner as to allow the heteroatoms to serve as coordination atoms.

Such organometallic ligands include cyclic aromatic compounds such as the cyclopentadienide ion [C₅H₅ (−1)] and various ring substituted and ring fused derivatives, such as the indenylide (−1) ion, that yield a class of bis(cyclopentadieyl) metal compounds, (i.e. the metallocenes); see, e.g., Robins et al., J. Am. Chem. Soc. 104:1882-1893 (1982); and Gassman et al., J. Am. Chem. Soc. 108:4228-4229 (1986), incorporated by reference. Of these, ferrocene [(C₅H₅)₂Fe] and its derivatives are prototypical examples, which have been used in a wide variety of chemical (Connelly et al., Chem. Rev. 96:877-910 (1996), incorporated by reference) and electrochemical (Geiger et al., Advances in Organometallic Chemistry 23:1-93; and Geiger et al., Advances in Organometallic Chemistry 24:87, incorporated by reference) electron transfer or “redox” reactions. Metallocene derivatives of a variety of the first, second and third row transition metals are potential candidates as redox moieties that are covalently attached to the nucleic acid. Other potentially suitable organometallic ligands include cyclic arenes such as benzene, to yield bis(arene)metal compounds and their ring substituted and ring fused derivatives, of which bis(benzene)chromium is a prototypical example. Other acyclic pi-bonded ligands such as the allyl(−1) ion, or butadiene yield potentially suitable organometallic compounds, and all such ligands, in conjunction with other pi-bonded and delta-bonded ligands constitute the general class of organometallic compounds in which there is a metal to carbon bond. Electrochemical studies of various dimers and oligomers of such compounds with bridging organic ligands, and additional non-bridging ligands, as well as with and without metal-metal bonds are potential candidate redox moieties in nucleic acid analysis.

When one or more of the co-ligands is an organometallic ligand, the ligand is generally attached via one of the carbon atoms of the organometallic ligand, although attachment may be via other atoms for heterocyclic ligands. Preferred organometallic ligands include metallocene ligands, including substituted derivatives and the metalloceneophanes (see page 1174 of Cotton and Wilkenson, supra). For example, derivatives of metallocene ligands such as methylcyclopentadienyl, with multiple methyl groups being preferred, such as pentamethylcyclopentadienyl, can be used to increase the stability of the metallocene. In a preferred embodiment, only one of the two metallocene ligands of a metallocene is derivatized.

Alternatively, in some embodiments, target nucleic acid may be labeled with an electroactive marker. Such electroactive markers can include, but are not limited to, ferrocene derivatives, anthraquinone, silver and silver derivatives, gold and gold derivatives, osmium and osmium derivatives, ruthinium and ruthinium derivatives, cobalt and cobalt derivatives and the like.

### Integration of the Microdevices into Diagnostic Systems

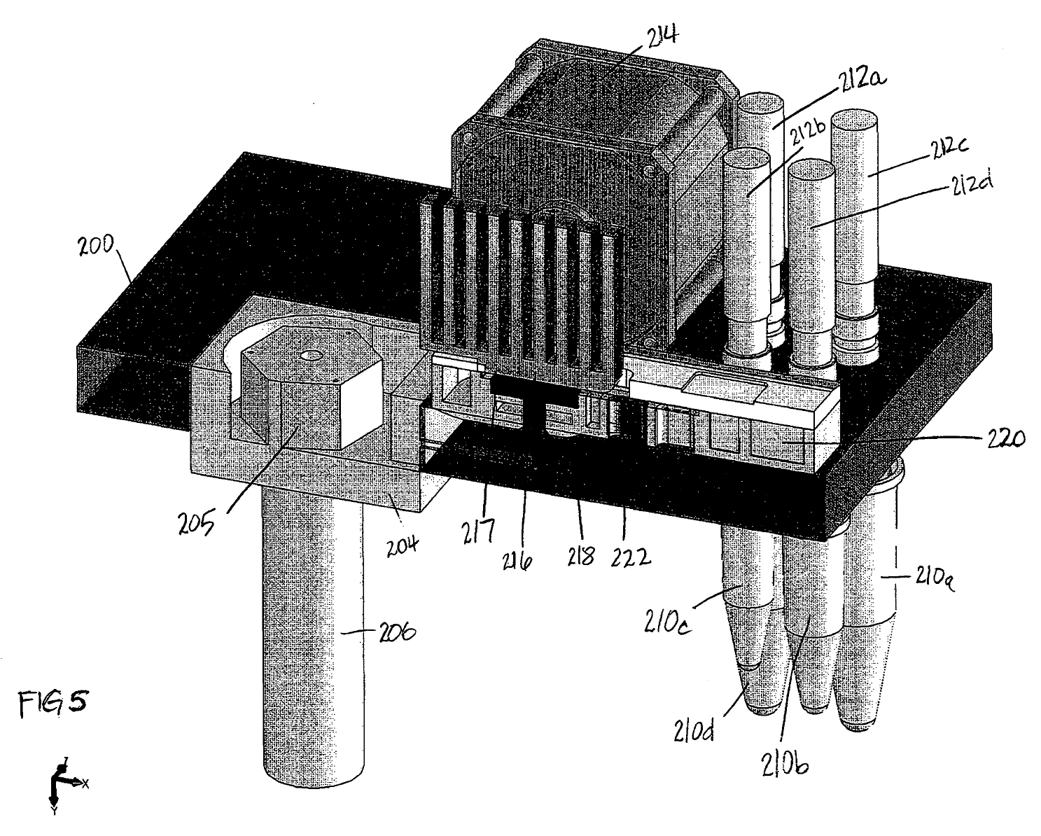

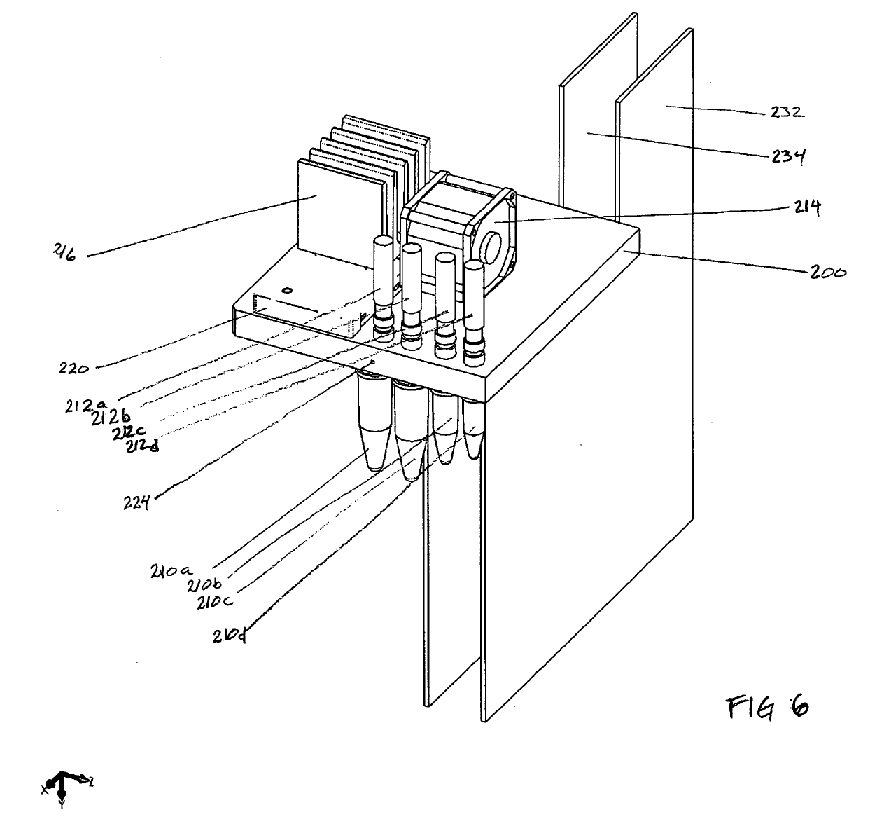

The microdevices of the present invention can be integrated into diagnostic systems for detecting a target agent in a sample. One embodiment of such a system that may utilize the microdevice of the present invention is described in co-pending application entitled “Electrochemical Detection Device with Reduced Footprint”, filed May 24, 2006 and is illustrated here in FIGS. 5 and 6. This embodiment of the device, as shown in FIG. 5, comprises a chassis (200), which, in a preferred embodiment is a fluidics monoblock having fluidics paths therethrough; a pump housing (212), a pump rotor (214) and a pump motor (216) for a peristaltic pump; reagent reservoirs (218 a-d) in a block configuration; valves (220 a-d) (in one embodiment, solenoid valves); a fan (214) for which to cool a heat sink (216), where heat sink (216) has a bottom surface (217) with a heater disposed or otherwise mounted thereon (not shown); the device of the invention (220) seen here in cross section, a pass through (222) for an electrical connection to the electrochemical detection chip; and a waste path (240).

FIG. 6 provides an expanded view of the system (200) showing the chassis as a fluidics monoblock (202), with a pump rotor (205) disposed therein and an air intake port (224) disposed therethrough. The fluidics monoblock (202) further comprises valve mounts (130 a-d), in fluid connection with reagent draw tubes (228 a-d), three of which are configured as inlets to draw reagent from reagent reservoirs (for example, 210 b-d) while one reagent draw tube is configured to be an outlet tube for one of the reagent reservoirs (for example, 200a). Valves (212 a-d) are shown exploded away from fluidics monoblock (202), but in operation would seat into valve mounts (230 a-d). Three of valves (212) control the flow of liquids, where one valve controls the flow of air, where the air separates the liquids in a fluidics path. Fan (214) is seen exploded away from fluidics monoblock (202), as is heat sink (216). The detection device of the present invention (220) is seen exploded away from the fluidics monoblock (202) above where it would be seated if in operational position. The detection device of the invention (220) will interface with the device electrically at pass through (222) and fluidic interface ports (226 a and b), where one fluidic interface port is a fluidic inlet and one fluidic interface port is a fluidic outlet. Also seen in FIG. 5 is control board (232) and processing board (234).

### EXAMPLES

The following examples are put forth so as to provide those of ordinary skill in the art with a complete disclosure and description of how to make and use the present invention, and are not intended to limit the scope of what the inventors regard as their invention, nor are they intended to represent or imply that the experiments below are all of or the only experiments performed. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees centigrade, and pressure is at or near atmospheric.

### Example 2

### Production of a Microdevice Using Deposition of Monomers

The electrodes for the microdevice of the invention are prepared using a hollow glass microtube as the outer structural component of the device. A 50 μm layer of gold is applied to the internal surface of the microtube by galvanic deposition from auric chloride solution, followed by rinsing and drying in isopropanol vapour. The electrodes are washed twice in 2-5% KOH solution for minutes, then rinsed with deionised water and washed twice in acetone for 5 minutes, then air dried at room temperature for 20 minutes. The electrodes were then mounted in a fluoroplastic holder and placed in a Soxhlet vessel where they were washed in hot isopropyl alcohol for 0.5-2 hours. The holder complete with electrodes was then removed from the Soxhlet vessel and the electrodes were dried in isopropyl alcohol vapour.

The electrodeposition of the polymer onto the gold surface of the electrode is carried out in a triple-electrode electrochemical cell, including a working electrode, and reference electrode and an auxiliary (counter) electrode. The working electrode is a metal potentiometric electrode prepared as described above, the auxiliary electrode is a length of gold or platinum wire, and the reference is a silver electrode.

Deposition is carried out using a potentiostat, applying a continuous voltage sweep on the working electrode. Depending on the desired thickness and properties of the polymer film, the lower potential sweep boundary, the upper potential sweep boundary, the voltage sweep rate and the number of sweep cycles are varied, typically from −500 mV to +800 mV, +1000 mV to +2000 mV (relative to the reference electrode), and 25-200 mV/sec. and 3-30 respectively.

Prior to polymerization of the polymer, a monomer (e.g., a pyrrole or a vinylpyrrolidone) is distilled in a standard water cooled apparatus at atmospheric pressure at 135-140° C., and stored in a sealed opaque vessel under N₂ at −20° C. to −5° C. The concentration of monomer in the electrochemical polymerisation solution is varied according to desired thickness of the polymer deposited on the gold surface.

A solution is made up for electrochemical polymerisation of the monomer as follows: 2.5 ml of freshly-distilled monomers conjugated with a thiol group and 0.02 g of SDS are dissolved in 20.0 ml of deionised water for the first deposition. 2.5 ml of freshly-distilled monomer and 0.02 g of SDS are dissolved in 20.0 ml of deionised water. A phosphate-saline buffer tablet is dissolved in 200 ml of deionised water and 4.0 mg of streptavidin are dissolved in 2 ml of the PBS. To the second monomer solution, 1 ml of streptavidin solution in PBS was added to the solution of monomer and SDS. The first and second solutions are placed in an orbital mixture for a period of approximately 10 minutes

The electrode, platinum wire and semi-micro reference electrode, connected to the potentiostat, are immersed in a container which has the first solution contained therein. A cyclical sweep of the electrode potential relative to the reference electrode was applied in the range +800 to +1800 mV at a sweep rate of 150 mV/sec. This is done for a period to allow the deposition of a monomer in a uniform monolayer on the gold surface of the electrode.

The process of formation of the polymer film was monitored with reference to the volt-ampere curve using a twin-coordinate chart recorder connected to the corresponding outputs of the potentiostat, and with reference to the total quantity of electricity passing through the electrode using an integrator and chart recorder connected to the corresponding outputs of the potentiostat. Throughout the deposition procedure checks are made to ensure that the quantity of electricity passing through the working electrode in the first and subsequent cycles does not differ by more than 15%; on reaching the specified thickness of the polymer film, the process is stopped.

The microtube with the polypyrrole film and bound streptavidin is removed from the well, rinsed with deionised water followed by 0.01M phosphate-saline buffer solution (pH 7.4), and placed in a microtube with 300 μl of storage solution, and prepared for conjugation of the oligonucleotides.

A custom synthesized oligonucleotide containing a biotin at the 5′ or the 3′ end is then added to the internal surface of the gold electrode. This procedure involves introducing approximately 100 nL of the probe solution containing the oligonucleotide (5 μmol/L), 400 mmol/L sodium chloride, and 0.1 mmol/L HCl, onto the internal surface of the electrode and then keeping the electrode at room temperature for 1 hour to immobilize the oligonucleotides onto the polymer surface via the avidin-biotin binding. Unattached probes are removed by washing the electrode with distilled water. The microdevice is then ready for use.

While this invention is satisfied by embodiments in many different forms, as described in detail in connection with the various embodiments of the invention, it is understood that the present disclosure is to be considered as exemplary of the principles of the invention and is not intended to limit the invention to the specific embodiments illustrated and described herein. Numerous variations may be made by persons skilled in the art without departure from the spirit of the invention. The scope of the invention will be measured by the appended claims and their equivalents. The abstract and the title are not to be construed as limiting the scope of the present invention, as their purpose is to enable the appropriate authorities, as well as the general public, to quickly determine the general nature of the invention. In the claims that follow, unless the term “means” is used, none of the features or elements recited therein should be construed as means-plus-function limitations pursuant to 35 U.S.C. §112, ¶6.

1. A device for the detection of target agents in a sample, the device comprising:
a) a hollow elongated microstructure comprising an inlet and outlet;
b) a conductive material evenly dispersed on the internal surface of the device;
c) a polymer uniformly distributed on the conductive material on the internal surface;
d) an adapter molecule associated with the polymer, and
e) a plurality of associated nucleic acids conjugated to the polymer surface of the device via the adapter molecule.

2. The device of claim 1, wherein the conductive material is gold.

3. The device of claim 1, wherein the conductive material is glassy carbon.

4. The device of claim 1, wherein the conductive material is platinum.

5. The device of claim 1, wherein the polymer is an ionically conductive biocompatible polymer capable of reversible reduction-oxidation.

6. The device of claim 1, wherein the polymer is an insulating polymer.

7. The device of claim 1, wherein the polymer is an electroconductive polymer.

8. The device of claim 1, wherein the polymers are created through deposition of monomeric units of the polymer.

9. The device of claim 7, wherein the polymers are created through deposition of monomeric units of the electroconductive polymer.

10. The device of claim 9, wherein the monomers are selected from the group consisting of are pyrrole, thiophene, furan and aniline.

11. The device of claim 1, wherein the adapter molecule is avidin, and wherein the nucleic acid is biotinylated to provide conjugation of the nucleic acid with the polymer.

12. The device of claim 1, wherein the adapter molecule is strepavidin, and wherein the nucleic acid is biotinylated to provide conjugation of the nucleic acid with the polymer.

13. The device of claim 1, wherein the device associated nucleic acids allow detection of a target agent though binding of a corresponding nucleic acid and subsequent binding of an electrochemical sensing agent.

14. The device of claim 1, wherein the device-associated nucleic acids comprise nucleic acids which share a single sequence, wherein the nucleic acids allow detection and quantification of a specific target agent.

15. The device of claim 1, wherein the device-associated nucleic acids comprise a plurality of nucleic acids with different sequences, wherein the nucleic acids allow detection and quantification n of multiple target agents.

16. The device of claim 1, wherein the inlet in fluid communication with a diagnostic detection system, said inlet connected to a flow channel created by the hollow microstructure of the device.

17. The device of claim 16, wherein nucleic acids corresponding to a target agent are introduced into the flow channel through the device inlet.

18. A device for the detection of target agents in a sample, the device comprising:
a) a hollow elongated microstructure comprising an inlet and outlet;
b) a conductive material evenly dispersed on the internal surface of the device;
c) an insulating polymer uniformly distributed on the conductive material on the internal surface;
d) an adapter molecule associated with the insulating polymer, and
e) a plurality of associated nucleic acids conjugated to the polymer surface via the adapter molecule.

19. The device of claim 18, wherein the conductive material is gold.

20. The device of claim 19, wherein the conductive material is glassy carbon.

21. The device of claim 18, wherein the conductive material is platinum.

22. The device of claim 18, wherein the polymer is an ionically conductive biocompatible polymer capable of reversible reduction-oxidation.

23. The device of claim 18, wherein the polymers are created through deposition of monomeric units of the electroconductive polymer.

24. The device of claim 18, wherein the adapter molecule is avidin, and wherein the nucleic acid is biotinylated to provide conjugation of the nucleic acid with the polymer.

25. The device of claim 18, wherein the adapter molecule is strepavidin, and wherein the nucleic acid is biotinylated to provide conjugation of the nucleic acid with the polymer.

26. The device of claim 18, wherein the device associated nucleic acids allow detection of a target agent though binding of a corresponding nucleic acid and subsequent binding of an electrochemical sensing agent.

27. The device of claim 18, wherein the device-associated nucleic acids comprise nucleic acids which share a single sequence, wherein the nucleic acids allow detection and quantification of a specific target agent.

28. The device of claim 18, wherein the device-associated nucleic acids comprise a plurality of nucleic acids with different sequences, wherein the nucleic acids allow detection and quantification n of multiple target agents.

29. The device of claim 18, wherein the inlet in fluid communication with a diagnostic detection system, said inlet connected to a flow channel created by the hollow microstructure of the device.

30. The device of claim 29, wherein nucleic acids corresponding to a target agent are introduced into the flow channel through the device inlet.

31. An integrated diagnostic system comprising the device of claim 1.

32. An integrated diagnostic system comprising the device of claim 18.
